(19) United States
(12) Patent Application Publication
(10) Pub. No.: US 2008/0307316 A1
(43) Pub. Date: Dec. 11, 2008

(54) SYSTEM AND METHOD FOR ASSIGNING USER PREFERENCE SETTINGS TO FIELDS IN A CATEGORY, PARTICULARLY A MEDIA CATEGORY

(75) Inventor: Waymen J. Askey, Cary, NC (US)

Correspondence Address: CONCERT TECHNOLOGY AND WITHROW & TERRANOVA, 100 REGENCY FOREST DRIVE , SUITE 160, CARY, NC, 27518, US

(73) Assignee: CONCERT TECHNOLOGY CORPORATION, Durham, NC (US)

(21) Appl. No.: 11/759,408

(22) Filed: Jun. 7, 2007

(51) Int. Cl. G06F 3/00

(52) U.S. Cl. 715/747

(57) ABSTRACT

A system and method for assigning a user preference setting for fields in a category, particularly a media category, using groups is disclosed. A category typically contains a plurality of fields. Instead of the user having to individually weight each field in the category to assign their preferences, the present invention establishes a plurality of groups and determines a group preference setting for the groups. The user then may assign the field to the particular group. The field will assume the group preference setting of the group to which the field is assigned. In this manner, the user can initially determine and/or change the preference setting of the field in a group by changing the group preference setting as desired and/or by assigning the field to a different group.

### FIELD OF THE INVENTION

The present invention is a system and method for assigning user preference settings for fields in a category, and particularly a media category, using groups and assigning the fields to the groups.

### BACKGROUND OF THE INVENTION

In recent years, there has been an enormous increase in the amount of digital media available online. Services, such as Apple's iTunes® for example, enable users to legally purchase and download music. Other services, such as Yahoo!® Music Unlimited and RealNetwork's Rhapsody® for example, provide access to millions of songs for a monthly subscription fee. YouTube® provides users access to video media. As a result, media items have become much more accessible to consumers worldwide. However, the increased accessibility of media has only heightened a long-standing problem for the media industry, which is namely the issue of linking users with media that matches their preferences.

Many companies, technologies, and approaches have emerged to address this issue. Being able to link users with media that matches their preferences allows companies to more effectively make recommendations of media items to users. Some companies assign ratings to attributes of identified media. The ratings are assembled to create a holistic classification for the media that is then used by a recommendation engine to produce recommendations. Other companies take a communal approach wherein recommendations are based on the collective wisdom of a group of users with similar tastes by profiling the habits of a particular user based on the information provided by the user and then searching similar profiles of other users. Either approach involves the soliciting, assembling, and reviewing of information about a user and/or the user's media likes or dislikes. That information is then used to establish user preferences on which to base media recommendations.

In some recommendation generation schemes, the user's media preferences are used to determine recommendations. User preferences allow more accurate targeting of recommendations. A user may establish preferences by assigning a weight to different media categories. These media categories may include for example, genre, artist, title, album or presentation, date of release, or the like. The weight assigned by the user for each of the media categories is used to establish the user's preferences, and from those preferences, a profile for that user. One example of such an approach is described in U.S. patent application Ser. No. 11/484,130, entitled “P2P NETWORK FOR PROVIDING REAL TIME MEDIA RECOMMENDATIONS,” filed on Jul. 11, 2006, which is co-assigned to the assignee of the instant application, and is hereby incorporated herein by reference in its entirety.

Categories, and particularly media categories, may however contain a large number of fields. To effectively assign a weight to a category to establish a user's preferences, the user must assign a weight to each of the fields within that category. This may be a difficult and time consuming effort for the user depending on the number of fields in the category. Accordingly, users may not, and in most cases, will not spend the time to assign individual weights to each of these fields. Alternatively, the user may opt to assign weights to only certain selected fields of interest. In either scenario, the weighting of the media category would be incomplete. As a result, preferences would be calculated using the incomplete weighting of a media category and thus would be inherently inaccurate. Accordingly, there is a need for a system and method to effectively assign preference weights to fields within a category, and particularly a media category, without the user having to individually assign a weight to each field within the category.

### SUMMARY OF THE INVENTION

The present invention is a system and method for assigning a user preference setting for fields in a category, particularly a media category, using groups. A category typically contains a plurality of fields. Instead of the user having to individually weight each field in the category to assign their preferences, the present invention establishes a plurality of groups and determines a group preference setting for the groups. The user then may assign the field to the particular group. The field will assume the group preference setting of the group to which the field is assigned. In this manner, the user can initially determine and/or change the preference setting of the field in a group by changing the group preference setting as desired and/or by assigning the field to a different group.

The group preference setting may be determined either prior to or after the field is assigned to the group. The user may establish the groups and/or determine the group preference setting. Alternatively, the group may be programmatically established and the group preference setting programmatically determined. The user may assign the field to the group, and/or the field may initially be programmatically assigned to the group based on a profile of the user. Additionally, one of the groups may be designated as a default group with a default group preference setting.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates an exemplary list of fields for a genre media category;

FIG. 2 illustrates an exemplary graphic user interface (GUI) of the preference setting screen displaying a plurality of groups of fields for the genre media category, wherein the fields are assigned to the groups according to one embodiment of the present invention;

FIG. 3 is a flow chart illustrating the process for establishing the group, determining the group preference setting, and assigning the field to the group according to one embodiment of the present invention;

FIG. 4 represents a user-server system on which the group may be established, the group preference setting may be determined, and the field may be assigned into the group according to an embodiment of the present invention;

FIG. 5 is a block diagram of a user account in the central/proxy server according to one embodiment of the present invention;

FIG. 6 illustrates an exemplary GUI of a preference setting screen displaying the groups of the fields in the genre media category, wherein the group is programmatically established and the group preference setting is programmatically determined according to one embodiment of the present invention;

FIG. 7 illustrates an exemplary GUI of a preference setting screen displaying the groups of the fields in the genre media category, wherein the groups are programmatically established, the group preference setting is programmatically determined, and the field is programmatically assigned to the group according to one embodiment of the present invention;

FIG. 8 illustrates an exemplary communication flow diagram between a user device and a central/proxy server, wherein the user device receives and downloads the media application from the central/proxy server, and wherein the central server receives and stores profile information from the user device, and sends a GUI Information to the user according to one embodiment of the present invention;

FIG. 9 is a block diagram illustrating more detail regarding components on the central/proxy server of FIG. 4 according to one embodiment of the present invention; and

FIG. 10 is a block diagram illustrating more detail regarding components on the user device of FIG. 4 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention is a system and method for assigning a user preference setting for fields in a category, particularly a media category, using groups. A category typically contains a plurality of fields. Instead of the user having to individually weight each field in the category to assign their preferences, the present invention establishes a plurality of groups and determines a group preference setting for the groups. The user then may assign the field to the particular group. The field will assume the group preference setting of the group to which the field is assigned. In this manner, the user can initially determine and/or change the preference setting of the field in a group by changing the group preference setting as desired and/or by assigning the field to a different group.

The group preference setting may be determined either prior to or after the field is assigned to the group. The user may establish the groups and/or determine the group preference setting. Alternatively, the group may be programmatically established and the group preference setting programmatically determined. The user may assign the field to the group, and/or the field may initially be programmatically assigned to the group based on a profile of the user. Additionally, one of the groups may be designated as a default group with a default group preference setting.

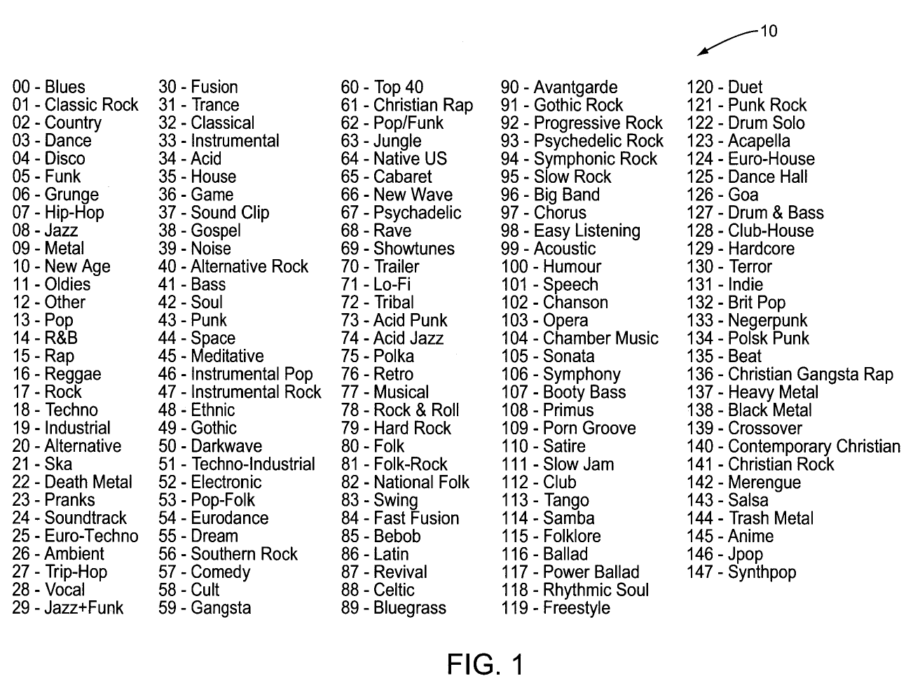

As background, a media category typically contains multiple fields. For example, WinAmp®, the proprietary media player written by Nullsoft, a subsidiary of Time Warner, Inc., currently identifies one hundred and forty-eight (148) different media fields in a music genre category as one example of a media category. FIG. 1 shows a list of these one hundred and forty-eight (148) different genre fields 10. Genre preference is one of the primary bases for users to determine their media item selections. Accordingly, rating media item recommendations based on the genre preference of the user provides an effective way for the media item client application to score and/or filter media item recommendations such that the media items being recommended are of interest to the user.

As further background for using media item preference settings to rate media item recommendations, in addition to U.S. patent application Ser. No. 11/484,130, entitled “P2P NETWORK FOR PROVIDING REAL TIME MEDIA RECOMMENDATIONS,” filed on Jul. 11, 2006, which is referenced above, another example of a media item preference setting and rating approach is described in U.S. patent application Ser. No. 11/696,475, entitled “SYSTEM AND METHOD FOR ASSIGNING USER PREFERENCE SETTINGS FOR A CATEGORY, AND IN PARTICULAR A MEDIA CATEGORY,” filed on Apr. 4, 2007, co-assigned to the assignee of the instant application, and is hereby incorporated herein by reference in its entirety. Please note that although the present invention is described with reference to media categories, it should be understood that the present invention applies to any type of category, and accordingly, the present invention is not limited to media categories.

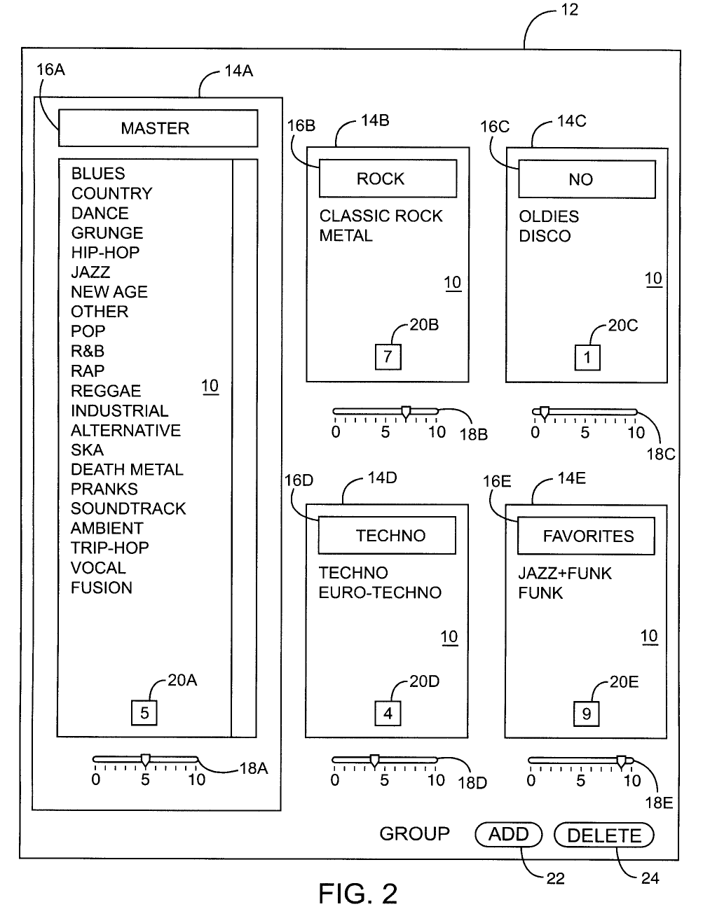

FIG. 2 illustrates an exemplary preference settings screen graphic user interface (GUI) 12 of a media item client application on a user device. FIG. 2 is provided to show an embodiment of the present invention to assign the preference setting to the field 10 by assigning the field to a group 14. FIG. 2 shows a plurality of groups 14A, 14B, 14C, 14D, and 14E which may be established by a user or which may be established programmatically by the media item client application. FIG. 2 shall be described with reference to one group 14, but it should be understood to apply to the plurality of groups 14A, 14B, 14C, 14D, and 14E. The group 14 typically has a title 16 and a preference selector 18 for determining a group preference setting 20. The preference selector 18 allows for a range of group preference settings 20 from 0 to 10, with 10 being the highest preference setting value. Although the present invention uses a sliding bar as the preference selector 18 with a certain range, it should be understood that the present invention may use any type of preference setting mechanism with any type of preference setting range or structure for establishing the group preference setting 20, and, therefore, should not be understood to be limited to the sliding bars of a certain range. The title 16 and the group preference setting 20 may be determined by the user, by manipulating the preference selector 18, or, alternatively, may be programmatically determined by the media item client application.

The title 16A of group 14A is “Master” and may be considered a default group 14. Because the “Master” group 14A may be considered a default group 14, the group preference setting 20 of the “Master” group 14A may be set at “5,” or an equivalent mid range value, as shown by the preference selector 18A. In addition to the “Master” group 14A, FIG. 2 shows a “Rock” group 14B, a “No” group 14C, a “Techno” group 14D, and a “Favorites” group 14E. Although FIG. 2 shows five groups 14A, 14B, 14C, 14D, and 14E, the present invention should not be understood to comprise any specific quantity of groups 14. The field 10 may initially be assigned into the “Master” group 14A as a default assignment and remain in the “Master” group 14A unless assigned into one of the other groups 14B, 14C, 14D, and 14E.

The user may assign the field 10 to the group 14 by using a basic drag and drop function of the user device. Alternatively, the user may manually input a field identifier, such as the name of the field 10 into the location of the group 14 on the GUI 12. The user may drag the field 10 from the group 14 that the field 10 is currently in, for example the “Master” group 14A, and drop the field 10 in the desired group 14, for example the “Rock” group 14B. Alternatively, the user may leave the field 10 in the “Master” group 14A, or any other group 14 to which the field 10 is currently assigned. Additionally, the user may add a group 14 using the “Add” selector 22 or delete a group 14 using the “Delete” selector 24.

FIG. 2 shows the “Classic Rock” field 10 and the “Metal” field 10 assigned to the group 14B with the title 16B “Rock.” The preference selector 18B of the “Rock” group 14B is set at “7,” which, therefore, is the group preference setting 20B of the “Rock” group 14B. Accordingly, the “Classic Rock” field 10 and the “Metal” field 10 assume the group preference setting 20B of “7.” Because the range of the preference selector 18B is 0 to 10, a group preference setting 20B of “7” indicates that the “Rock” group 14B, and, therefore, the “Classic Rock” field 10 and the “Metal” field 10, are more preferred than the field 10 in the group 14 with the group preference setting 20 of less than “7,” and, conversely, less preferred than the field 10 in the group 14 with the group preference setting 20 of more than “7.”

For example, FIG. 2 shows the “No” group 14C having the group preference setting 20C of “1.” Accordingly, the “Oldies” field 10 and the “Disco” field 10 assume the group preference setting 20C of the “No” group 14C and are assigned the preference setting of “1,” because of the “No” group 14C group preference setting 20C of “1.” Therefore, the “Classic Rock” field 10 and the “Metal” field 10 are more preferred than the “Oldies” field 10 and the “Disco” field 10. On the other hand, the “Favorites” group 14E has the group preference setting 20E of “9.” The “Jazz+Funk” field 10 and the “Funk” field 10 assume the group preference setting 20E of the “Favorites” group 14E and also have the preference setting of “9.” Therefore, the “Classic Rock” field 10 and the “Metal” field 10 are less preferred than the “Jazz+Funk” field 10 and the “Funk” field 10. Note that if it is desired to change the preference setting of the field 10, the field 10 can be moved to another group 14 having the desired group preference setting 20, or the group preference setting 20 of the group 14 to which the field 10 is assigned can be changed.

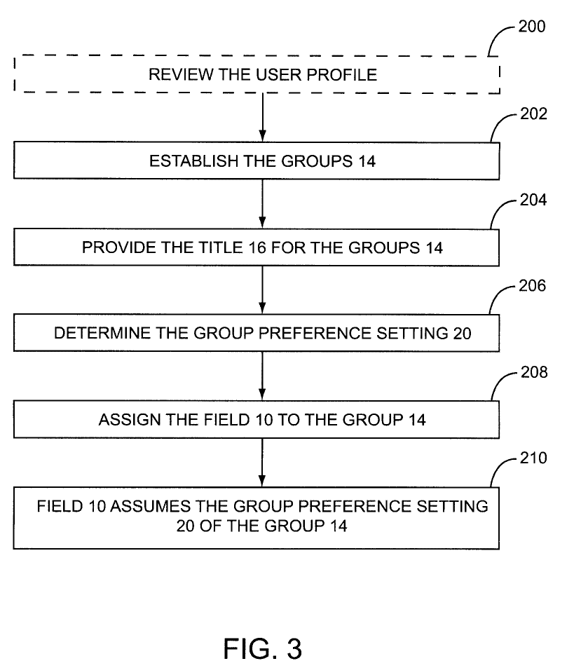

In this regard, FIG. 3 illustrates the process for establishing the group 14, determining the group preference setting 20, and assigning the field 10 to the group 14. FIG. 3 is provided to illustrate the basic process of one embodiment of the present invention that may be performed by the user or programmatically by the media item client application. The process may start by a review of the user's profile information (step 200). The review may be performed programmatically by the media item client application reviewing profile information provided by the user. Alternatively, the review may not be programmatically performed. In such a case, the user may perform this intuitively by inherently knowing his or her media item likes or dislikes.

The groups 14 are then established (step 202). The groups 14 are not limited to being any specific quantity. The user may establish the group 14 or the group 14 may be established programmatically by the media item client application. For example, from the review of the user profile information (step 200), the media item client application may determine that the user has a very consistent play history with the media items played associated with a very limited number of the fields 10, for example the “Rock” field 10 and the “Hard Rock” field 10. As such, the groups 14 that are established may be more focused on the different “Rock” related fields 10, with the non-“Rock” related fields 10 assumed to be in the default group 14, for example the “Master” group 14A. Alternatively, the non-“Rock” related fields 10 may be relegated to the group 14 with the very low group preference setting 20.

Once the groups 14 are established, the title 16 may be given to the group 14 (step 204). The title 16 may be any designation the user desires, as the user may provide manually, or as may be programmatically provided based on the user profile. Also, the title 16 may be a standard title 16. The title 16 provides a descriptive identification for the group 14 and a differentiation with the other groups 14. The differentiation may, for example, be based on degrees of preference, on a characteristic of the media item, such as genre, date, or release, or on any other factor or indicia.

The group preference setting 20 is determined for the group 14 (step 206). The group preference setting 20 may be determined manually by the user or programmatically based on the user's profile. In addition, the group preference setting 20 may be a pre-determined, standard group preference setting 20. The group preference setting 20 may be any type or range of designation to determine the user's degree of preference for the group 14. The group preference setting 20 may be determined prior to the field 10 being assigned to the group 14, or, alternatively, after the field 10 is assigned to the group 14.

The field 10 may be assigned to the group 14 (step 208). Although FIG. 3 shows the field 10 assigned to the group 14 after the group preference setting 20 is determined, as discussed above, the field 10 may also be assigned to the group 14 prior to the group preference setting 20 being determined. The field 10 may be assigned to the group 14 using any normal or usual manner, as discussed above with reference to FIG. 2. The field 10 then assumes the group preference setting 20 for the group 14 to which the field 10 is assigned (step 210).

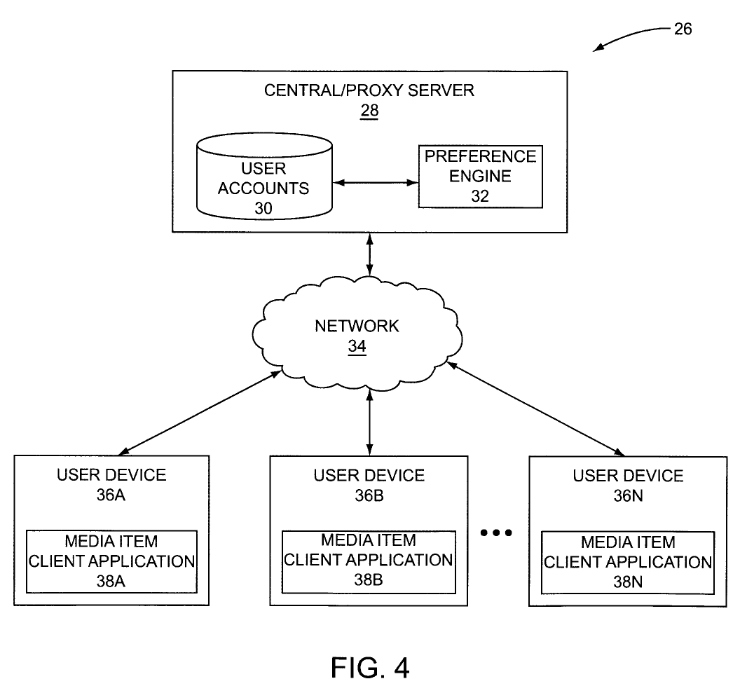

FIG. 4 illustrates a user/server system 26 that may employ or facilitate the present invention for establishing the group preference setting 20 of the field 10. FIG. 4 is provided to illustrate an exemplary application of the present invention to a certain system and, accordingly, it should be understood that the present invention is not limited to any specific type of client application, program, or software. The user/server system 26 supports a media item client application for managing media item recommendations sent and received by users subscribed to the media item client application. Other applications of the user/server system 26 include scoring media items based on the preference settings, acquiring and sending recommendations of media items, and acquiring and playing media items, for example. The user/server system 26 has a central/proxy server 28. The primary purpose of the central/proxy server 28 is to manage the flow of information and services provided to users of the user/server system 26, including, but not limited to, receiving requests for and establishing new user accounts, providing the media item client application to the user, managing and storing user information, and managing the flow of recommendations for media items to users. The central/proxy server 28 operates in a user-server relationship with users, although the present invention may be implemented in a peer-to-peer configuration where features of the central/proxy server 28 are distributed among one or more peer nodes or devices. Note that the central/proxy server 28 may be implemented as a number of servers operating in a collaborative fashion.

The central/proxy server 28 may be comprised of a database of user accounts 30 and a preference engine 32. The user accounts 30 may contain a record of accounts for each user known to the central/proxy server 28 and information concerning the aspects of the user's activities on the user/server system 26. The preference engine 32 is a program, algorithm, or control mechanism that may be used to establish the group 14, establish the group preference setting 20, and/or assign the field 10 into the group 14. The central/proxy server 28 is also able to communicate with other devices and systems over a network 34. The network 34 may be any private network or distributed public network such as, but not limited to, the Internet.

The user/server system 26 also includes a number of user devices 36A-36N which are optionally connected to the central/proxy server 28 and each other via the network 34. The user devices 36 may be any type of computing device that is capable of performing communications over the network 34 to reach the central/proxy server 28 and other user devices 36. Examples of user devices 36 include, but are not limited to: home computers; computers at work; laptop computers; wireless portable media player (PMP) devices; hand-held computer devices, such as personal digital assistants (PDAs) with remote communication capabilities; and the like. A web browser (not shown) may be included within each user device 36 to provide the user an interface for Internet-based communications, including those with the central/proxy server 28. This allows the user device 36 to download a media item client application 38 onto the user device 36 from the central/proxy server 28 to provide a customized software interface to the central/proxy server 28. After the media item client application 38 is downloaded onto a user device 36 from the central/proxy server 28, the media item client application 38 executes on the user device 36. Note that while three user devices 36A, 36B, and 36N are illustrated, the present invention may be used with any number of user devices 36.

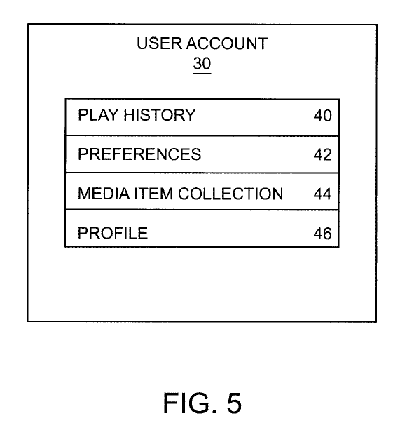

FIG. 5 is a block diagram illustrating the components of an exemplary user account 30 in the central/proxy server 28 according to one embodiment of the present invention. FIG. 5 provides an overview of the structure of the user account 30, the information recorded therein, and a reference for describing the interaction between the central/proxy server 28 and the user devices 36. The user account 30 may store a record of certain information concerning the user and the user's activities involving media items. The information in the user account 30 may be used to establish the groups 14, determine the group preference setting 20, and/or assign the field 10 to the group 14.

The user account 30 records the user's play history 40. The user's play history 40 is a time-stamped record of each media item played by the user. The user account 30 may also contain information regarding the user's particular preferences 42. The user's preferences 42 may relate to the different likes and dislikes of the user based on certain identified media categories. The media categories, for example, may be genre, artist, date of release of the media item, and other information. Additionally, the user account 30 may store a record of the groups 14, the group preference settings 20, and/or the fields 10 assigned to the groups 14. Also, the user account 30 may have a record of the user's media item collection 44, and profile 46 information provided by the user. The play history 40, preferences 42, media item collection 44, and other information provided by the user at the time of registering with the central/proxy server 28 may be included in and used to further develop and update the profile 46 of the user. Additionally, the profile 46 may include a statistical compilation of the aforementioned information.

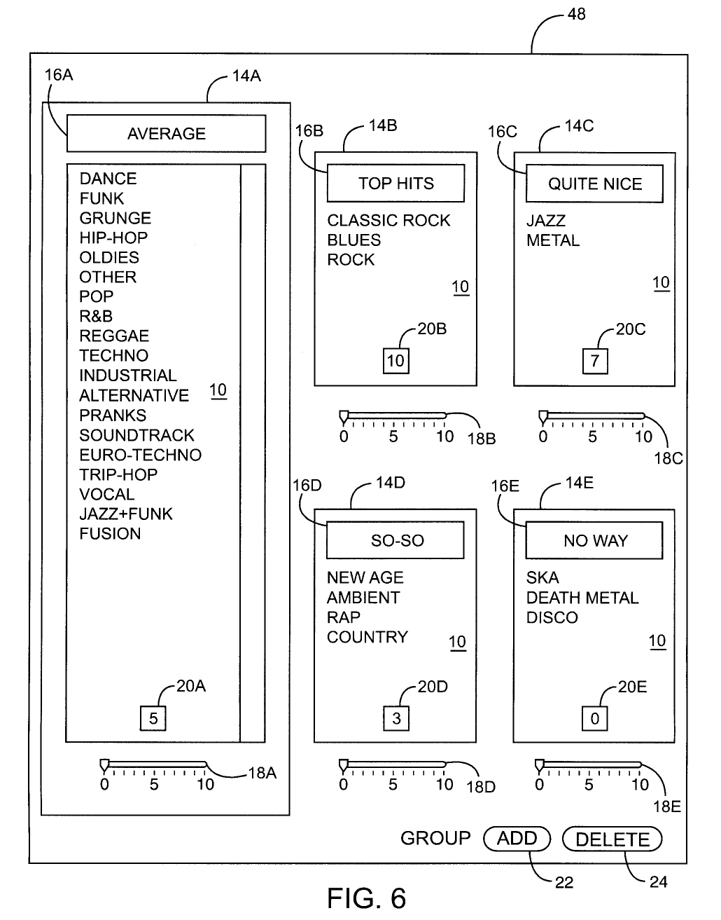

FIG. 6 illustrates an exemplary preference settings screen GUI 48 of a media item client application on a user device 36 similar to FIG. 2 and including additional detail on programmatically provided aspects of the present invention. FIG. 6 is provided to show another embodiment of the present invention. FIG. 6 shows the GUI 48 for assigning a preference setting to the field 10 using the group 14. The group 14 displayed on the GUI 48 is programmatically established and the group preference setting 20 is programmatically determined by the media item client application. In other words, when the user opens the GUI 48, the GUI 48 will display the group 14 with the title 16 and the preference setting 20. The user then may assign the field 10 to the group 14 as desired.

Additionally, because the preference setting 20 is determined programmatically, the preference selector 18 was not used to determine the preference setting 20. The preference selector 18 is shown at “0” even though the preference setting 20 for the group 14 is shown at a different value. For example, group 14B has a preference setting 20B of “10” while the preference selector 18B is at “0.” In this manner, the user may easily and readily realize that the preference setting 20 was determined programmatically. Additionally or alternatively, the preference selector 18 and/or the preference setting 20 may have a different appearance, for example a different color or shading, to distinguish the preference setting 20 determined programmatically from the preference setting 20 determined by the user. Also, a textual message may be used to inform the user whether the preference setting 20 was determined programmatically or by the user.

The group 14 may be established and the preference setting 20 may be determined on a standard basis. For example, each of the five groups illustrated in FIG. 6 14A, 14B, 14C, 14D, and 14E has a title 16A, 16B, 16C, 16D and 16E, which conveys a range or degree of preference to the user. The title 16A is “Average,” the title 16B is “Top Hits,” the title 16C is “Quite Nice,” the title 16D is “So-So,” and the title 16E is “No Way.” In this manner, the user may discern a degree of preference of the group 14 by reading the title 16. For example, title 16B “Top Hits” denotes that the group 14B is a more preferred group 14 than the group 14E with the title 16E “No Way.” In addition, the GUI 48 may include the group preference settings 20A, 20B, 20C, 20D, and 20E to provide the user with a value to differentiate the degree of preference between the groups 14. The group preference setting 20 may be any type of visual indication or display.

FIG. 6 shows the group preference settings 20A, 20B, 20C, 20D, and 20E programmatically determined with values regularly spaced between the range of 0 to 10. The group 14E has the lowest group preference setting 20E of “0,” and the group 14B has the highest group preference setting 20B of “10.” The other groups 14A, 14C, and 14D have the group preference settings 20A of “5,” 20C of “7,” and 20D of “3.”

When the user opens the GUI 48, the field 10 may be in the group 14A with the title 16A “Average.” The user may then assign the field 10 to the group 14 that the user desires. The user may assign the field 10 to the group 14 by simply moving the field 10 to the group 14. The user may move the field 10 by dragging and dropping the field 10 from the group 14A to one of the other groups 14. Alternatively, the user may assign the field 10 to the group 14 by manually entering the field 10 designation. For example, the user may enter the “Rock” field 10 in the group 14B which will then automatically delete the “Rock” field 10 from the previous group 14A that the field 10 was in.

FIG. 6 shows that the user assigned “Classic Rock,” “Blues,” and “Rock” from the group 14A to the group 14B. The user may elect to not move the field 10 from the group 14A and, thereby, not assign the field 10 to another group 14. In such a case, the field 10 will remain assigned in the group 14A and will assume the group preference setting 20A of “5.” For example, the user did not assign the “Dance” field 10 to another group 14 and, therefore, the “Dance” field 10 will assume the group preference setting 20A of “5.”

Once the user opens the GUI 48, the user may make any changes to the GUI 48 if desired. The user may add a group 14 using the “Add” selector 22 or delete a group 14 using the “Delete” selector 24. Additionally, the user may change the group preference setting 20 using the preference selector 18. Once the user uses the preference selector 18, the group preference setting 20, which was programmatically determined, is over-ridden and the group preference setting 20 for the group 14 will, thereafter, be determined by the preference selector 18.

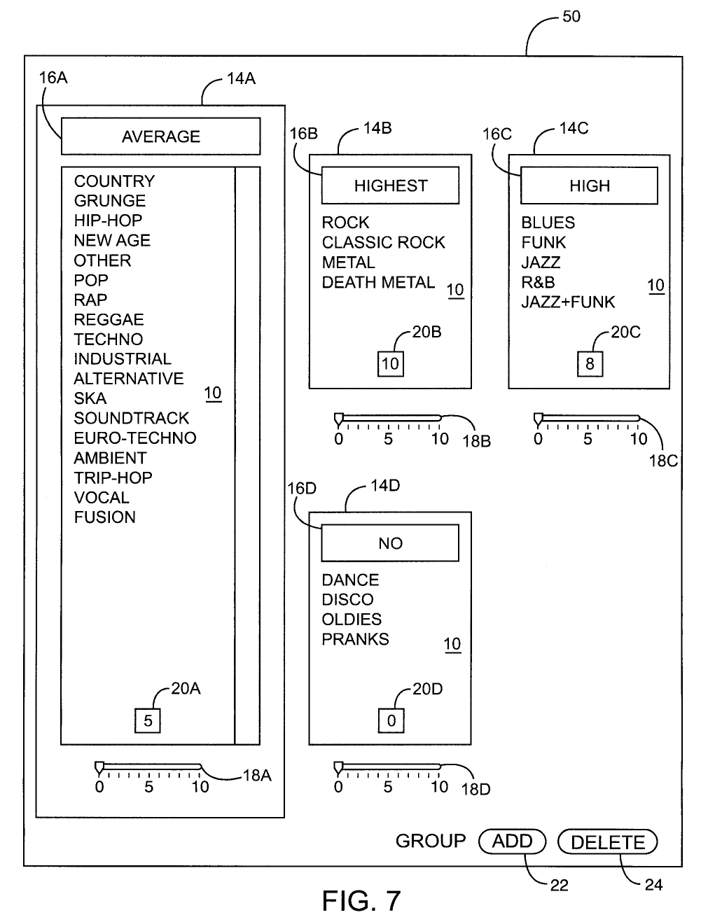

FIG. 7 illustrates an exemplary preference settings screen GUI 50 of a media item client application on a user device 36 similar to FIGS. 2 and 6, and including additional detail on programmatically provided aspects of the present invention. FIG. 7 is provided to show another embodiment of the present invention. As shown in FIG. 7, the media item client application may programmatically establish the group 14, determine the group preference setting 20, and assign the field 10 to the group 14 based on the user's profile 46 (FIG. 5). Similar to the embodiment illustrated in FIG. 6, because the preference setting 20 is determined programmatically, the preference selector 18 was not used to determine the preference setting 20. The preference selector 18 is shown at “0” even though the preference setting 20 for the group 14 is shown at a different value. For example, group 14A has a preference setting 20A of “5” while the preference selector 18A is at “0.” In this manner, the user may easily and readily realize that the preference setting 20 was determined programmatically. Additionally or alternatively, the preference selector 18 and/or the preference setting 20 may have a different appearance, for example a different color or shading, to distinguish the preference setting 20 determined programmatically from the preference setting 20 determined by the user. Also, a textual message may be used to inform the user whether the preference setting 20 was determined programmatically or by the user.

From the user's profile 46, it is determined that the user highly prefers the “Rock” genre with the user preferring some “Rock” fields 10 slightly more than other “Rock” fields 10. The groups 14B and 14C are established based on the user's “Rock” preference. The titles 16B and 16C are programmatically provided to reflect and denote the user's preferences with the title 16B being “Highest” and the title 16C being “High.” Similarly, the group preference settings 20B and 20C are programmatically determined based on the user's profile 46, and, particularly, play history 40 and preferences 42 (FIG. 5). The group preference setting 20B is determined to be “10” and the group preference setting 20C is determined to be “8.” The fields 10 are programmatically assigned to the groups 14B and 14C based on the user's profile 46. For example the “Rock,“ Classic Rock,” “Metal,” and “Death Metal” fields 10 are assigned to the group 14B and, therefore, assume the group preference setting 20B of “10.” The “Blues,” “Funk,” “Jazz,” “R&B,” and “Jazz-Funk” fields 10 are assigned to the group 14C and, therefore, assume the group preference setting 20C of “8.”

Based on the user's profile 46, the group 14D was established with the title 16D of “No,” and the group preference setting 20D was determined to be “0.” The user's profile 46 may be strongly negative about certain of the fields 10, and there may be no media items of the field 10 in the user's media item collection 44 (FIG. 5). The “Dance,” “Disco,” “Oldies,” and “Pranks” fields 10 may be the fields 10 on which the user's profile 46 is strongly negative. Accordingly, based on the user's profile 46, the “Dance,” “Disco,” “Oldies,” and “Pranks” fields 10 may be assigned into the group 14D and assume the group preference setting 20D of “0.”

Additionally, the user's profile 46 may indicate that although the user does not highly prefer the field 1 0, the user has some interest in the field 10. For example, the user's interest may be based on an infrequent play history 40 and/or a few media items in the user's media item collection 44 related to the field 10. The field 10 in which the user has some interest may be assigned to the group 14A with the title 16A of “Average.” Based on the user's profile 46, and particularly the user's play history 40 and/or media item collection 44, the field 10 in the group 14A may assume the group preference setting 20A of “5.” The group preference setting 20A, therefore, indicates some interest by the user but not necessarily a low preference or a high preference.

The GUI 50 may be especially helpful for the user upon the initialization of the media item client application 38 by the user. The GUI 50 may be developed and provided by the media item client application 38 based on the information provided by the user when the user registered with the central/proxy server 28 (FIG. 4). The preference engine 32 (FIG. 4) in the central/proxy server 28 may analyze the information provided by the user which may include the play history 40, preferences 42, media item collection 44, and profile 46 in the user account 30 (FIG. 5) and programmatically establish the group 14, provide the title 16, determine the group preference setting 20, and assign the field 10 to the group 14. Once the user opens the GUI 50, the user may make any changes to the GUI 50 if desired. The user may add the group 14 using the “Add” selector 22 or delete the group 14 using the “Delete” selector 24. Additionally, the user may assign the field 10 to a different group 14 and/or change the group preference setting 20 using the preference selector 18. Once the user uses the preference selector 18, the group preference setting 20 which was programmatically determined is over-ridden and the group preference setting 20 for the group 14 will, thereafter, be determined by the preference selector 18.

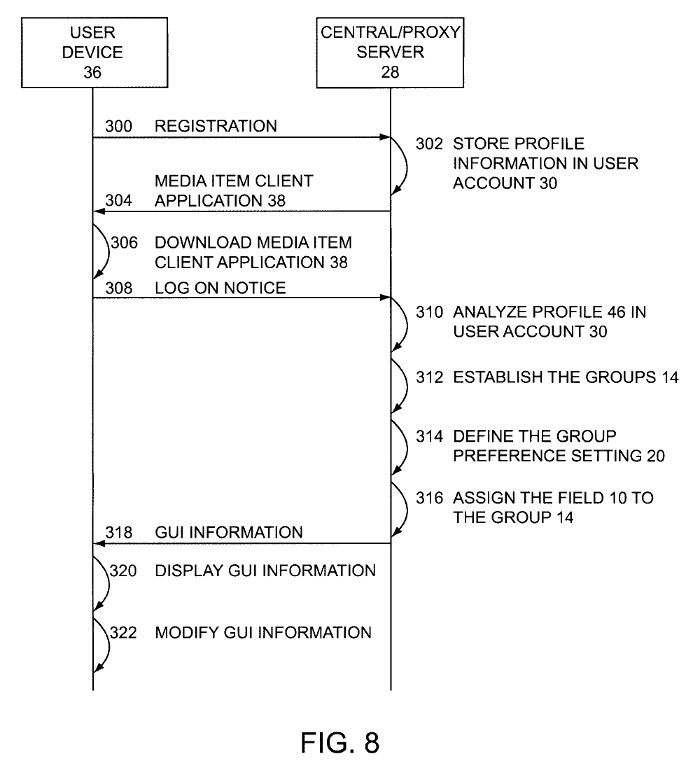

FIG. 8 illustrates an exemplary communications flow diagram between the central/proxy server 28 and the user device 36 to show the process for programmatically establishing the group 14, determining the group preference setting 20, and/or assigning the field 10 to the group 14 which will be displayed on the GUI 12, 48, 50, according to one embodiment of the present invention. The user subscribes for the media item client application by sending a registration from the user device 36 to the central/proxy server 28 (step 300). The registration may include the user profile 46 information. The central/proxy server 28 receives the registration, registers the user, and stores the profile information in the user account 30 (step 302). The central/proxy server 28 sends the media item client application 38 to the user device 36 (step 304).

The user device receives and downloads the media item client application 38 from the central/proxy server 28 (step 306). When the user desires to run the media item client application 38, the user sends a log on notice to the central/proxy server 28 via the user device 36 (step 308). The central/proxy server 28, using the preference engine 32 (FIG. 4), analyzes the user's profile 46 in the user account 30 (step 310). Based on the analysis, the central/proxy server 28 establishes the group 14 (step 312), determines the preference setting 20 (step 314), and assigns the field 10 (step 316). As discussed above, the user, instead of the central/proxy server 28, may establish the group 14, determine the group preference setting 20, and/or assign the field 10 to the group 14.

The central/proxy server 28 sends information regarding the group 14, group preference setting 20, and/or field 10 assigning information, collectively referred to in FIG. 8 as the “GUI Information,” to the user device 36 (step 318). The user device 36 displays the GUI Information to the user (step 320) and the user may then modify the GUI Information as the user desires (step 322).

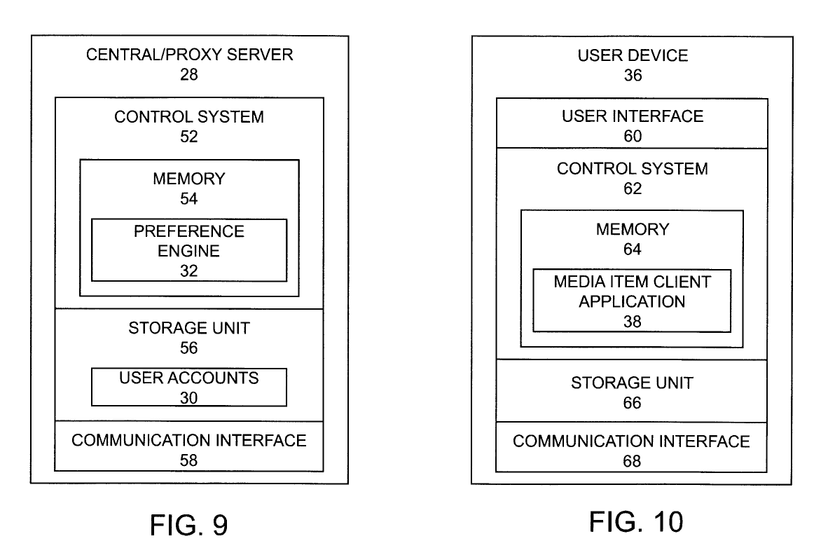

FIG. 9 is a block diagram illustrating more detail regarding the exemplary components that may be provided by the central/proxy server 28 of FIG. 4 to perform the present invention. In general, the central/proxy server 28 may be processor or microprocessor-based, and include a control system 52 having associated memory 54. The preference engine 32 is at least partially implemented in software and stored in the memory 54. The central/proxy server 28 also includes a storage unit 56 operating to store the user accounts 30. The storage unit 56 may also store the preference engine 32. The storage unit 56 may be any number of digital storage devices such as, for example, one or more hard-disc drives, one or more memory cards, Random Access Memory (RAM), one or more external digital storage devices, or the like. The user accounts 30 may alternately be stored in the memory 54. A communication interface 58 may include a network interface allowing the central/proxy server 28 to be communicably coupled to the network 34 (FIG. 4).

FIG. 10 is a block diagram illustrating more detail regarding the exemplary components that may be provided within the user device 36 of FIG. 4 to provide the present invention. In general, the user device 36 includes a user interface 60, which may include components such as a display, speakers, a user input device, and the like. The user device 36 may be processor or microprocessor-based, and also include a control system 62 having associated memory 64. In this example, the media item client application 38 is at least partially implemented in software and stored in the memory 64. The user device 36 also includes a storage unit 66. The storage unit 66 may be any number of digital storage devices such as, for example, one or more hard-disc drives, one or more memory cards, RAM, one or more external digital storage devices, or the like. The user device 36 also includes a communication interface 68. The communication interface 68 may include a network interface communicatively coupling the user device 36 to the network 34 (FIG. 4).

Additionally, the functionality of the present invention can be embodied in any computer-readable medium for use by or in connection with a computer-related system or method. A computer-readable medium is an electronic, magnetic, optical, semiconductor, or other physical device or means that can transmit, contain, or store a computer program, instructions or data for use by or in connection with a computer-related system or method.

Those skilled in the art will recognize improvements and modifications to the preferred embodiments of the present invention. All such improvements and modifications are considered within the scope of the concepts disclosed herein and the claims that follow.

What is claimed is:

1. A method of assigning a preference setting to a field in a category, comprising the steps of:
establishing a plurality of groups in the category;
determining a group preference setting for one of the plurality of groups; and
assigning a field to one of the plurality of groups, wherein the field assumes the group preference setting of the one of the plurality of groups to which the field is assigned.

2. The method of claim 1, further comprising the step of providing a title for each of the plurality of groups.

3. The method of claim 1, wherein assigning the field to one of the plurality of groups is performed prior to determining a group preference setting.

4. The method of claim 1, wherein establishing a plurality of groups comprises establishing a plurality of groups programmatically.

5. The method of claim 1, wherein determining a group preference setting comprises determining a group preference setting programmatically.

6. The method of claim 5, wherein determining a group preference setting programmatically comprises determining a group preference setting programmatically based on a profile of a user.

7. The method of claim 1, wherein assigning the field to one of the plurality of groups comprises assigning the field to one of the plurality of groups programmatically.

8. The method of claim 7, wherein assigning the field to one of the plurality of groups programmatically comprises assigning the field to one of the plurality of groups programmatically based on a profile of a user.

9. The method of claim 1, wherein the one of the plurality of groups is a default group with a default group preference setting.

10. The method of claim 1, wherein the group preference setting is used to rate media item recommendations.

11. A system for assigning a preference setting to a field in a category, comprising:
a control system adapted to:
establish a plurality of groups in the category;
determine a group preference setting for one of the plurality of groups; and
assign a field to the one of the plurality of groups, wherein the field assumes the group preference setting of the one of the plurality of groups to which the field is assigned.

12. The system of claim 11, wherein the control system is further adapted to provide a title for the plurality of groups.

13. The system of claim 11, wherein the control system is adapted to assign the field to the one of the plurality of groups prior to determining a group preference setting.

14. The system of claim 11, wherein the control system is adapted to establish a plurality of groups programmatically.

15. The system of claim 11, wherein the control system is adapted to determine a group preference setting programmatically.

16. The system of claim 15, wherein the control system is adapted to determine a group preference setting programmatically based on a profile of a user.

17. The system of claim 11, wherein the control system is adapted to assign the field to the one of the plurality of groups programmatically.

18. The system of claim 17, wherein the control system is adapted to assign the field to the one of the plurality of groups programmatically based on a profile of a user.

19. The system of claim 11, wherein the one of the plurality of groups is a default group with a default group preference setting.

20. The system of claim 11, wherein the group preference setting is used to rate media item recommendations.

21. A computer-readable medium comprising instructions for instructing a computer to:
establish a plurality of groups in a category;
determine a group preference setting for one of the plurality of groups; and
assign a field to the one of the plurality of groups, wherein the field assumes the group preference setting of the one of the plurality of groups to which the field is assigned.

22. The computer-readable medium of claim 21, further comprising instructions for instructing a computer to provide a title for the plurality of groups.

23. The computer-readable medium of claim 21, wherein the instruction to assign the field to the one of the plurality of groups, comprises an instruction to assign the field to the one of the plurality of groups prior to determining a group preference setting.

24. The computer-readable medium of claim 21, wherein the instruction to establish a plurality of groups, comprises an instruction to establish a plurality of groups programmatically.

25. The computer-readable medium of claim 21, wherein the instruction to determine a group preference setting, comprises an instruction to determine a group preference setting programmatically.

26. The computer-readable medium of claim 25, wherein the instruction to determine a group preference setting programmatically, comprises an instruction to determine a group preference setting programmatically based on a profile of the user.

27. The computer-readable medium of claim 21, wherein the instruction to assign the field to the one of the plurality of groups, comprises an instruction to assign the field to the one of the plurality of groups programmatically.

28. The computer-readable medium of claim 27, wherein the instruction to assign the field to the one of the plurality of groups programmatically, comprises an instruction to assign the field to the one of the plurality of groups programmatically based on a profile of the user.

29. The computer-readable medium of claim 21, wherein the one of the plurality of groups is a default group with a default group preference setting.

30. The computer-readable medium of claim 21, wherein the group preference setting is used to rate media item recommendations.

31. A user interface generated by an application executing on a processor, comprising:
a preference setting screen, comprising:
a plurality of groups in a category, and
a field in the category, wherein the field is assigned to one of the plurality of groups.

32. The user interface of claim 31, wherein the preference setting screen further comprises a preference selector, wherein by actuating the preference selector a group preference setting is determined for the one of the plurality of groups.

33. The user interface of claim 31, wherein the preference setting screen further comprises an add selector, wherein a group may be added to the preference setting screen by actuating the add selector.

34. The user interface of claim 31, wherein the preference setting screen further comprises a delete selector, wherein a group may be deleted from the preference setting screen by actuating the delete selector.

35. The user interface of claim 31, wherein the preference setting screen further comprises a title for a group.
